(19) United States
(12) Patent Application Publication
(10) Pub. No.: US 2018/0213214 A1
(43) Pub. Date: Jul. 26, 2018

(54) PROTECTING A DISPLAY SCREEN FROM PRYING EYES

(71) Applicant: International Business Machines Corporation, Armonk, NY (US)

(72) Inventors: Xiaoyu Li, Beijing (CN); Wenzhe Shi, Beijing (CN); Ziying Xin, Beijing (CN); Li Zhang, Beijing (CN); Wenya Zhou, Beijing (CN)

(21) Appl. No.: 15/414,858

(22) Filed: Jan. 25, 2017

(51) Int. Cl. H04N 13/04

(52) U.S. Cl. CPC H04N 13/0434; H04N 2013/0465; H04N 13/0497; H04N 13/0454

(57) ABSTRACT

A method, system, and computer product for driving a display system in a screen protection mode includes receiving one or more image data, generating a first image signal and a second image signal based on the one or more image data, responsive to receiving an input indicating a screen protection mode, displaying a first image on a display screen of the display system based on the first image signal, displaying a second image on the display screen based on the second image signal, and passing through the first image by a viewing device and blocking the second image by the viewing device, so that a viewer wearing the viewing device indentifies the first image. Left-eye and right-eye lenses of the viewing device are configured to operate in a same manner.

The present disclosure relates to a method for protecting a visual screen, such as a computer monitor, display or mobile device display, from prying eyes.

### BACKGROUND

Recently, an importance of protecting a screen that may include sensitive data and information has been increased. Examples of well-known methods for the screen protection include putting a privacy filter (e.g., also known as a privacy screen or monitor filter) on a screen or monitor. It decreases a viewing angle, allowing only a viewer situated directly in front of the screen to view the contents of the screen. However, it cannot prevent a person within the viewing angle, such as a shoulder surfer. Even if the person is out of the viewing angle and cannot identify detailed information, he or she still can see some vague outline, which may also leak some sensitive information. Thus, there is a need to develop a new technique or method for more effectively protecting a screen from the shoulder surfer.

### SUMMARY

In an aspect of the present disclosure, a computer-implemented method for driving a display system is provided. The method includes receiving one or more image data, generating a first image signal and a second image signal based on the one or more image data, responsive to receiving an input indicating a screen protection mode, displaying a first image on a display screen of the display system based on the first image signal, displaying a second image on the display screen based on the second image signal, receiving the first and second images displayed on the display screen by a viewing device, and passing through the first image by the viewing device and blocking the second image by the viewing device, so that a viewer wearing the viewing device indentifies the first image. Left-eye and right-eye lenses of the viewing device are configured to operate in a same manner.

In an aspect of the present disclosure, a display system is provided. The display system includes a control device, a display screen, and a viewing device. The control device receives one or more image data and generates a first image signal and a second image signal based on the one or more image data, responsive to receiving an input indicating a screen protection mode. The display screen displays a first image based on the first image signal and a second image based on the second image signal. The viewing device passes through the first image and blocks the second image, so that a viewer wearing the viewing device indentifies the first image. Left-eye and right-eye lenses of the viewing device are configured to operate in a same manner.

In an aspect of the present invention, a computer program product including a computer-readable storage medium having computer readable program instructions embodied therewith. The computer readable program instructions are executable by at least one processor to cause a computer to perform a computer-implemented method for driving a display system. The method includes receiving one or more image data, generating a first image signal and a second image signal based on the one or more image data, responsive to receiving an input indicating a screen protection mode, displaying a first image on a display screen of the display system based on the first image signal, displaying a second image on the display screen based on the second image signal, and passing through the first image displayed on the display screen by a viewing device and blocking the second image displayed on the display screen using the viewing device. Left-eye and right-eye lenses of the viewing device are configured to operate in a same manner.

### BRIEF DESCRIPTION OF THE DRAWINGS

FIG. 1 depicts a block diagram of an example display system according to an exemplary embodiment of the present disclosure;

FIGS. 2A to 2C are diagrams illustrating how desired and interfering images are displayed on a display screen according to an exemplary embodiment of the present disclosure;

FIG. 3 depicts a block diagram of an example display system when desired and interfering images are combined based on different polarization directions according to an exemplary embodiment of the present disclosure;

FIG. 4A are example timing diagrams of a desired image, an interfering image, and a viewing device's shutter control signal according to an exemplary embodiment of the present disclosure;

FIG. 4B depicts a block diagram of an example display system when desired and interfering images are combined based on different time frames according to an exemplary embodiment of the present disclosure;

FIG. 5A depicts a block diagram of an example display system in which a display mode is switched between a protection mode and a non-protection mode according to an exemplary embodiment of the present disclosure;

FIGS. 5B-5D are example diagrams illustrating how the display system of FIG. 5A operates according to a selected display mode according to an exemplary embodiment of the present disclosure;

FIG. 6 is a flow chart illustrating a method driving a display system according to an exemplary embodiment of the present disclosure; and

FIG. 7 is a block diagram of a computing system according to an exemplary embodiment of the present disclosure.

### DETAILED DESCRIPTION OF THE EMBODIMENTS

Embodiments of the present invention will now be described in detail on the basis of the drawings. However, the following embodiments do not restrict the invention claimed in the claims. Moreover, all combinations of features described in the embodiments are not necessarily mandatory for the architecture of the present invention Like numbers are assigned to like elements throughout the description of the embodiments of the present invention.

According to exemplary embodiments of the present invention, a method, system, and computer product for driving a display system to protect an image displayed on a screen from unauthorized viewers. A display system according to an exemplary embodiment of the present disclosure may operate in at least one of modes: a screen protection mode and a normal mode, depending on a control input. In the context of the present disclosure, the normal mode is understood to mean modes, such as a two-dimensional (2D) and a three-dimensional (3D), other than the screen protection mode. The control input may be generated by a user or by an algorithm preloaded in the display system or provided by an external device remotely connected thereto via a network.

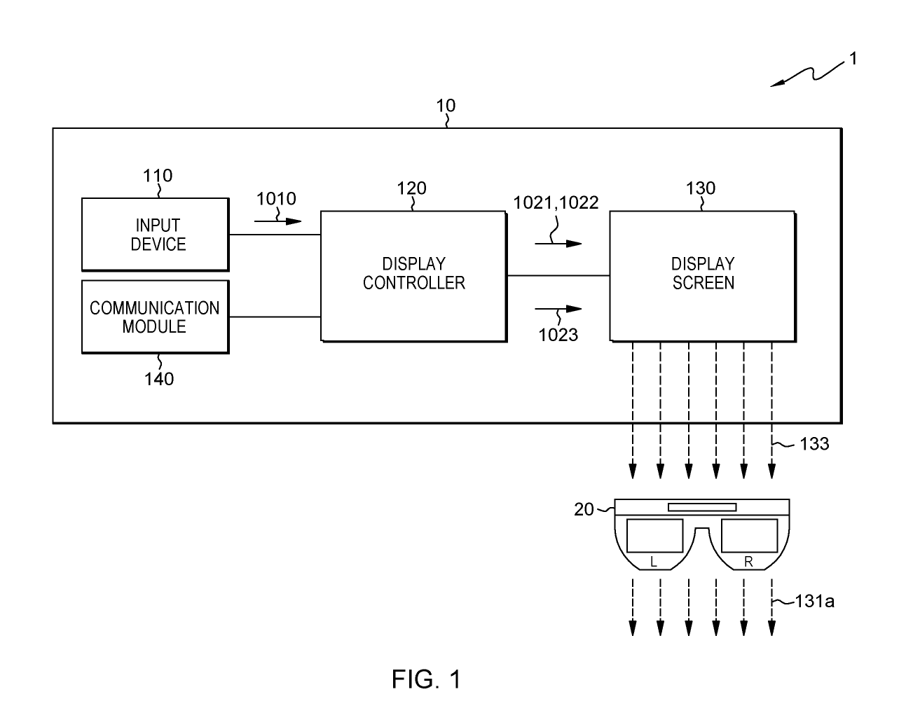

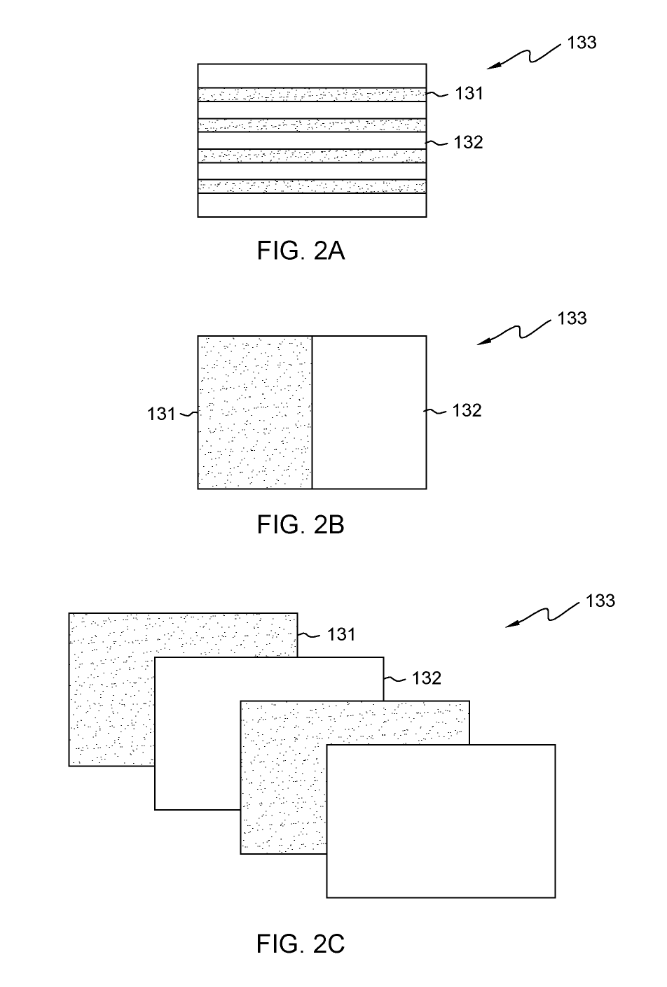

FIG. 1 depicts a block diagram of an example display system 1 according to an exemplary embodiment of the present disclosure. FIGS. 2A to 2C are diagrams illustrating how desired and interfering images 131 and 132 are displayed on a display screen 130 according to an exemplary embodiment of the present disclosure.

Referring to FIG. 1, the display system 1 may include a display apparatus 10 for displaying an image and a viewing device 20 that helps a viewer see the image. The display apparatus 10 may include an input device 110, a display controller 120, a display screen 130 (e.g., display panel), and a communication module 140. Image data 1010 (e.g., RGB) may be provided through the input device 110 from an external source (e.g., computing system, media player, etc.) which is locally or remotely connected to the display apparatus 10. The display controller 120 may generate first and second image signals 1021 and 1022 and a scan control signal 1023 (e.g., a gate control signal) based on the image data 1010. The first image signal 1021 may include a first data voltage signal (not shown) and a first data control signal (not shown) which are used to drive the display screen 130 to display a desired image 131 (FIG. 2A). The second image signal 1022 may include a second data voltage signal (not shown) and a second data control signal (not shown) which are used to drive the display screen 130 to display an interfering image 132 (FIG. 2A). The communication module 140 may be used to exchange a control signal generated from the display controller 120 to the viewing device 20. Although not shown, in some embodiments, the display controller 120 may include a data driver (not shown) for generating the first and second voltage signals based on the image data 1010.

Referring to FIGS. 2A and 2B, the first and second image signals 1021 and 1022 may be configured for the desired image 131 and 132 to be projected (or displayed) on the display screen 130 to form a combined image 133. In some embodiments, the interfering image 132 may have a similar color, line, texture, contrast or the like to the desired image 131, but different in terms of polarization directions, time periods (e.g., frames) where they are displayed on the screen 130. By way of examples, the combined image 133 may be formed in an interlaced format where the desired image 131 and the interfering image 132 are mixed in lines (FIG. 2A); a side-by-side format where the desired image 131 and the interfering image 132 are arranged in a horizontal direction at the same time (e.g., the same frame) (FIG. 2B), a top/down format where the desired image 131 and the interfering image 132 are displayed in a vertical direction at the same time (e.g., the same frame) (not shown), a frame sequential format where the desired image 131 and the interfering image 132 are arranged in a time division manner (FIG. 2C). The combined image 133 may be provided to the viewing device 20, and the viewing device 20 may receive the combined image 133 and output the desired image 131, while blocking the interfering image 132. In some aspects, the desired and interfering images 131 and 132 may be projected on the display screen 130 to form the combined image 133. For example, if a viewer (e.g., non-authorized viewer) who does not wear the viewing device 20 sees the combined image 133 displayed on display screen 130, the viewer might not identify the desired image 130 from the combined image 133 since the interfering image 132 would remain to be viewed by the viewer without being blocked.

In some embodiments, the desired image 131 and the interfering image 132 may be distinguished from each other in terms of a variety of ways such as, but are not limited to: polarization directions thereof, time periods (e.g., frame) when the images 131 and 132 are displayed on the display screen 130.

In some embodiments, the desired image 131 and the interfering image 132 may have different polarization directions from each other. Thus, when the combined image 133 is directly seen by a viewer without using the viewing device 20 (or even if the viewing device 20 is used, if the polarization direction of the viewing device 20 is not matched to the desired image 131), the desired image 131 might not be seen clearly.

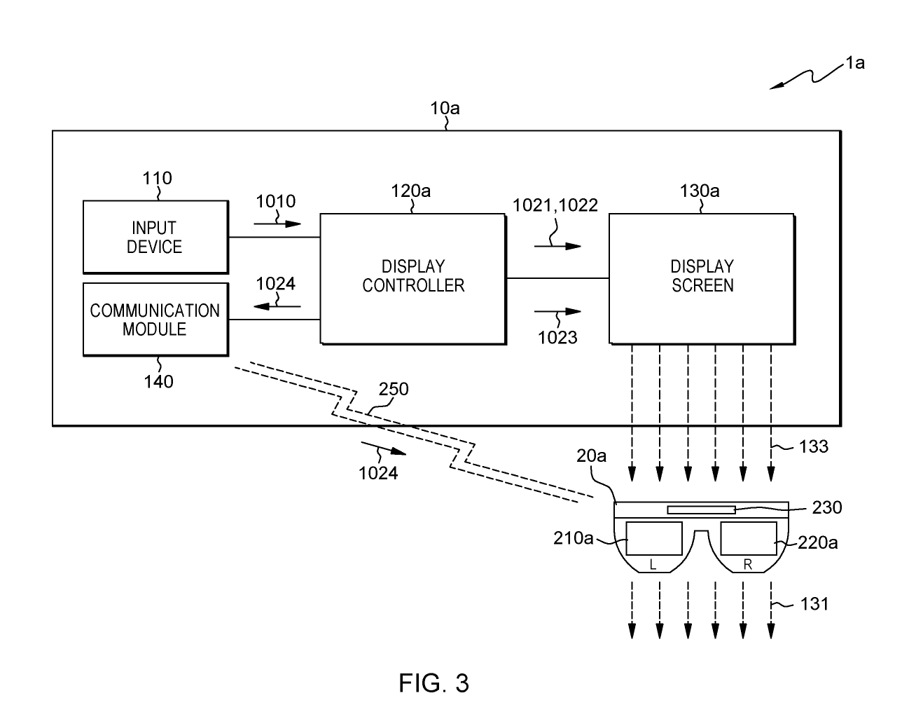

FIG. 3 depicts a block diagram of an example display system 1a when the desired image 131 and the interfering image 132 are combined based on different polarization directions according to an exemplary embodiment of the present disclosure. Referring to FIG. 3, the display apparatus 10a may have substantially the same configuration as the display apparatus 10 of FIG. 1 except the display controller 120a and the display screen 130a; for example, the display controller 120a and the display screen 130a may be configured to display the desired image 131 with the first polarization P1 and the interfering image 132 with the second polarization P2. Thus, the first and second image signals 1021 and 1022 generated by the display controller 120a may be provided to the display screen 140a. The display screen 140a may be configured to display the desired image 131 with the first polarization direction P1 and the interfering image 132 with the second polarization direction P2. For example, referring to the examples depicted in FIGS. 3 and 2A to 2C, the desired image 131 may be displayed on the screen 130a with the first polarization direction P1, and the interfering image 132 may be displayed on the screen 130a with the second polarization direction P2.

In some aspects, the desired image 131 with the first polarization P1 and the interfering image 132 with the second polarization P2 are displayed on the display screen 130 at the same time, however in other aspects, the images 131 and 132 are displayed on the display screen 130 in an alternate manner. Thus, a combined image 133 of the desired and interfering images 131 and 132 may be provided to a viewing device 20a. The viewing device 20a may be configured to select (or pass) the desired image 131 with the first polarization direction P1 from the combined image 133 and block the interfering image 132 with the second polarization direction P2, as depicted in FIG. 3. In some embodiments, the viewing device 20a may be implemented using a polarization eyeglass whose left-eye lens 210a and right-eye lens 220a have the same polarization direction as the first polarization direction P1 of the desired image 131.

If a viewer who is authorized to access or see an image displayed on the screen 130a wears the viewing device 20a whose polarization direction is matched to (or similar) the polarization direction P1 of the desired image 131, the viewer may be able to see (or identify) the desired image 131 whereas the interfering image 132 may be filtered out by the viewing device 20a because the polarization direction P2 of the interfering image 132 is not matched to the polarization direction (e.g., P1) of the viewing device 20a. On the other hand, other viewers who are not authorized to access or see the image displayed on the screen 130a might not wear such viewing device 20a, and thus the non-authorized viewers may only see the combined image 133, and might not identify the desired image 131 since the interfering image 132 might not be blocked and still remained to the viewer's eye.

In some embodiments, if viewers (e.g., non-authorized viewer) who do not wear the viewing device 20a see the combined image 133 displayed on the display screen 130a, the viewer might not identify the desired image 130 from the combined image 133 since the interfering image 132 would remain to be viewed by the viewer without being blocked. Thus, the image displayed on the screen 130a may be seen by the authorized viewer wearing the viewing device 20a matched to the polarization direction P1 of the desired image 131 and may be protected from being seen by the other unauthorized viewers who do not wear the viewing device 20a. This feature facilitates protecting an image displayed on the screen 130a from being seen by the unauthorized viewers. In some embodiments, the first polarization direction P1 may be orthogonal to the second polarization direction P2 (e.g., one of the first and second polarization directions P1 and P2 is perpendicular to another one thereof).

In some embodiments, the first polarization direction P1 may be controlled by a viewer's input or a predetermined algorithm (not shown) loaded in the display controller 120a, so that the display system 1a can further be protected even in a situation where an unauthorized viewer endeavors or identifies information pertaining to the first polarization direction P1 used for the desired image 131. In some aspects, the polarization direction of the desired image 131 might not be fixed to the first polarization direction P1, instead may vary according to the viewer's input or the predetermined algorithm (not shown) loaded in the display controller 120a. In this case, the viewing device 20a may be configured to adaptively change its polarization direction to be the same as or similar to the polarization direction (e.g., P1) of the desired image 131 as the polarization direction of the desired image 131 varies. To this end, the display controller 120a may be configured to control the first and second image signals 1021 and 1022 to change the first polarization direction P1 of the desired image 131 and the second polarization direction P2 of the interfering image 132, respectively, according to the viewer's input or the predetermined algorithm. Further, the display system 1a may include a communication module 140 that receives a polarization control signal 1024 from the display controller 120a and transmits the polarization control signal 1024 to the viewing device 20a over a communication network 250. The viewing device 20a may include a communication module 230 that receives the polarization control signal 1024 and change polarization direction of lenses of the viewing device 20a based on the polarization control signal 1024. The communication network 250 may include wired communications based on Internet, local area network (LAN), wide area network (WAN), or the like, or wireless communications based on code division multiple access (CDMA), global system for mobile communication (GSM), wideband CDMA, CDMA-2000, time division multiple access (TDMA), long term evolution (LTE), wireless LAN, Bluetooth, Infrared, WiFi, or the like.

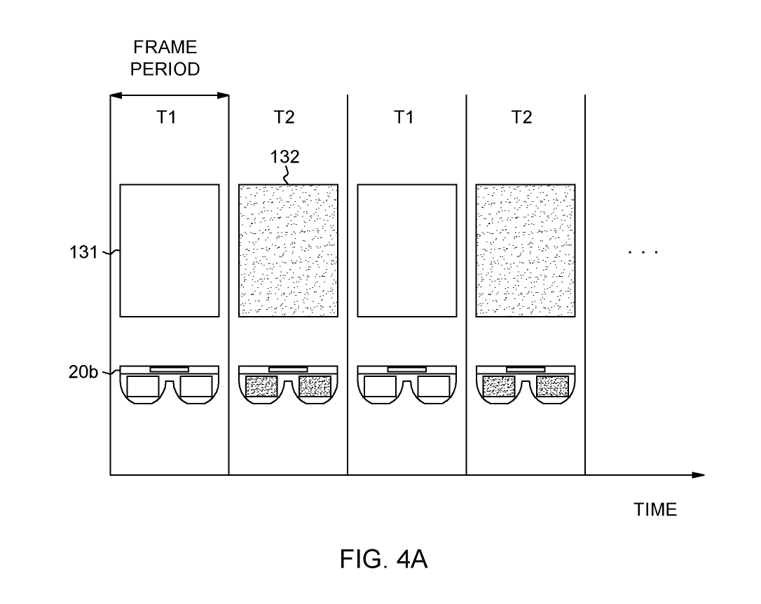

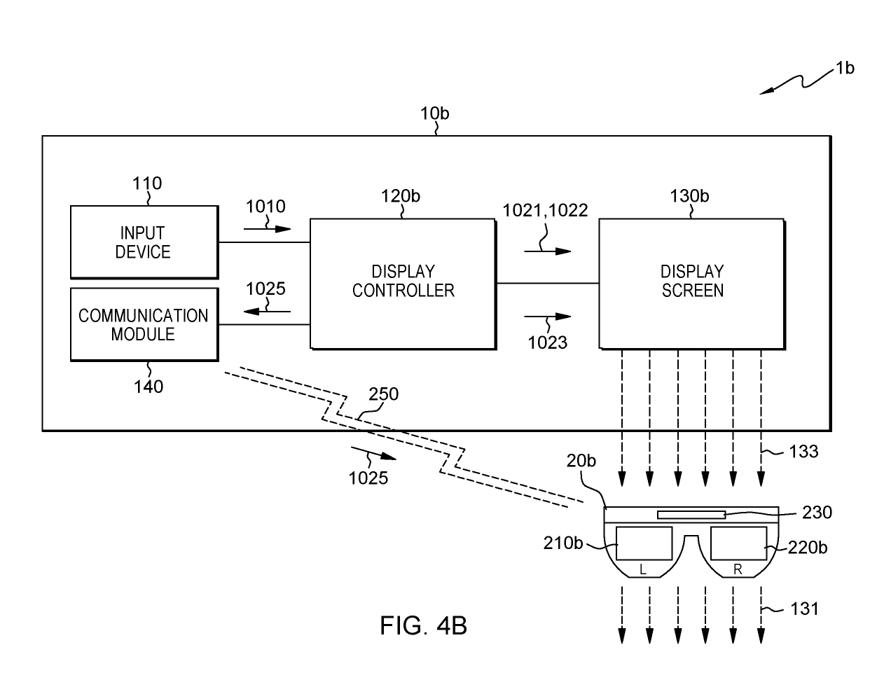

In some embodiments, the desired image 131 and the interfering image 132 may be displayed on a screen in different time frames. FIG. 4A are example timing diagrams of the desired image 131, the interfering image 132 and a viewing device's open/closed state according to an exemplary embodiment of the present disclosure. FIG. 4B depicts a block diagram of an example display system 1b when the desired image 131 and the interfering image 132 are combined based on different time frames according to an exemplary embodiment of the present disclosure. Referring to the example depicted in FIG. 4B, the display apparatus 10b may have substantially the same configuration as the display apparatus 10 of FIG. 1 except the display controller 120b and the display screen 130b; for example, the display controller 120b and the display screen 130b may be configured to display the desired image 131 and the interfering image 132 in different time frames T1 and T2 (e.g., alternatively in successive time frames T1 and T2). Thus, referring to the example depicted in FIG. 4A, the first and second image signals 1021 and 1022 generated by the display controller 120b may be provided to the display screen 130b to display the desired image 131 in the first frame T1 and the interfering image 132 in the second frame T2. The viewing device 20b may be implemented using a shutter glass whose left-eye lens 210b and right-eye lens 220b are controlled to be open during the first frame T1 to select (or pass) the desired image 131 and closed during the second frame T2, e.g., alternatively controlled in like manner in successive time frames T1 and T2. Referring back to FIGS. 4A and 4B, a combined image 133 (FIG. 4B) of the desired image 131 and the interfering image 132 displayed in the first and second frames Ti and T2 may be provided to a viewer. If a viewer who is authorized to access or see an image displayed on the screen 130b wears the viewing device 20b whose left-eye and right-eye lenses 210b and 220b being open in synchronization with (or during) the first frames T1 where the desired image 131 is displayed, the viewer may be able to see (or identify) the desired image 131 whereas the interfering image 132 may be filtered out by the viewing device 20b because the second frames T2 where the interfering image 132 are displayed are not in synchronization with the time periods where the viewing device 20b's lenses 210b and 220b are open. On the other hand, other viewers who are not authorized to access or see the image displayed on the screen 130b might not wear the viewing device 20b, and thus the non-authorized viewers may only see the combined image 133 and might not identify the desired image 131 since the interfering image 132 might not be blocked and still remained to the viewer's eye.

In some embodiments, if viewers (e.g., non-authorized viewer) who do not wear the viewing device 20b see the combined image 133 displayed on the display screen 130b, the viewer might not identify the desired image 130 from the combined image 133 since the interfering image 132 would remain to be viewed by the viewer without being blocked. Thus, the image displayed on the screen 130b may be seen to the authorized viewer wearing the viewing device 20b and may be protected from being seen by the other unauthorized viewers who do not wear the viewing device 20b. This feature facilitates protecting an image displayed on the screen 130b from the unauthorized viewers.

Although it is illustrated in FIG. 4A that the desired images 131 and the interfering images 132 are displayed in an alternate manner over successive time frames. However, exemplary embodiments of the present disclosure are not limited thereto. For example, the interfering images 132 may be displayed for every N consecutive desired images 131 (N is an integer equal to or greater than one). In some aspect, a blank time period (where no image is displayed) may exist between the desired images 131 and the interfering images 132.

In some embodiments, referring back to FIG. 4B, the display apparatus 10b may include the communication module 140 that receives a shutter control signal 1025 generated by the display controller 120b and transmits the shutter control signal 105 to the viewing device 20b over the communication network 250. Thus, the viewing device 20b may have a communication module 230 for receiving the shutter control signal 1025 and may control the time periods where the left-eye and right-eye lenses 210b and 220b are opened or closed based on the shutter control signal 1025.

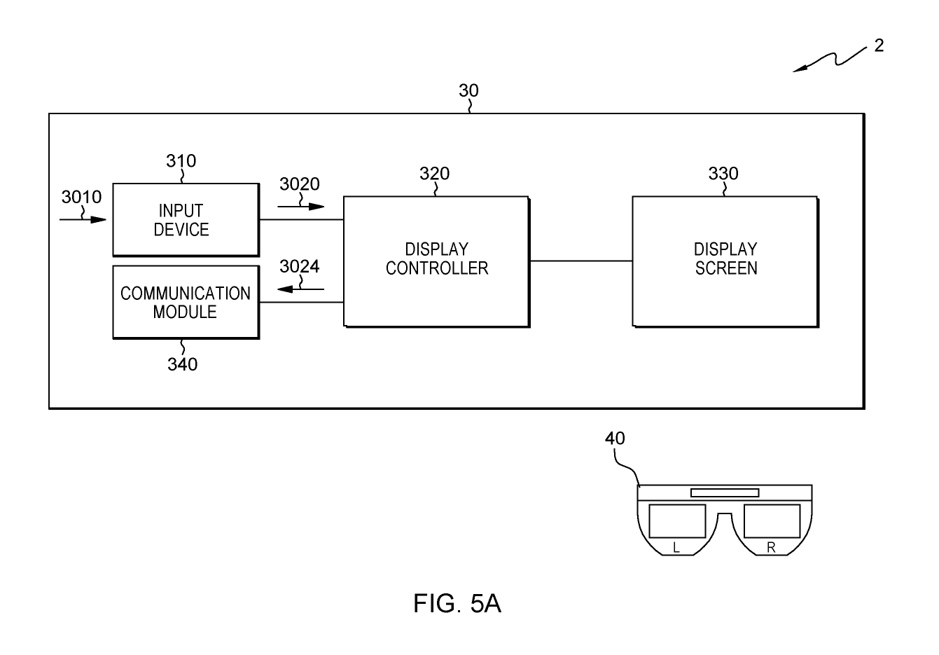

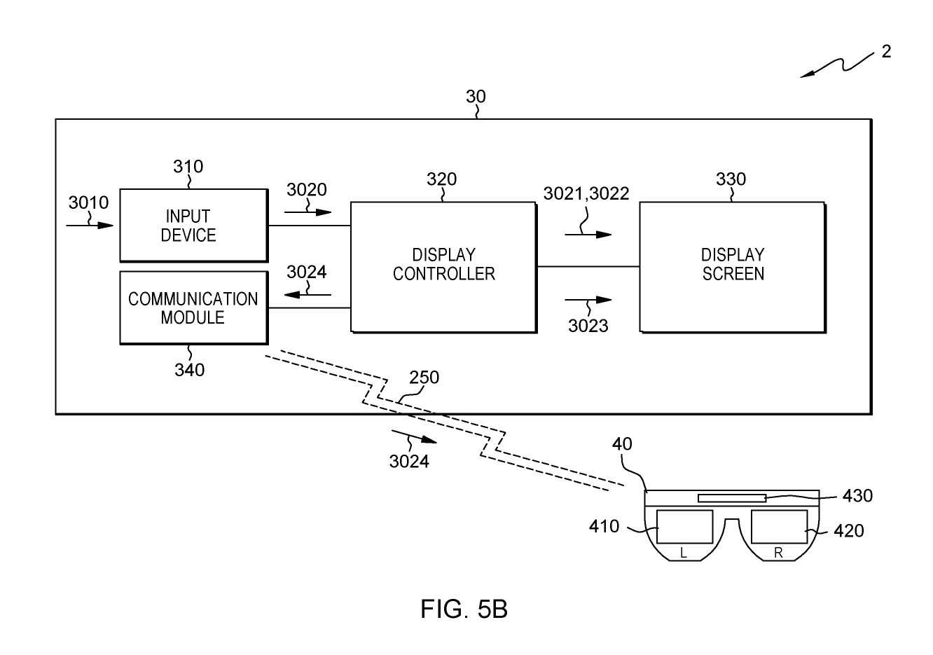

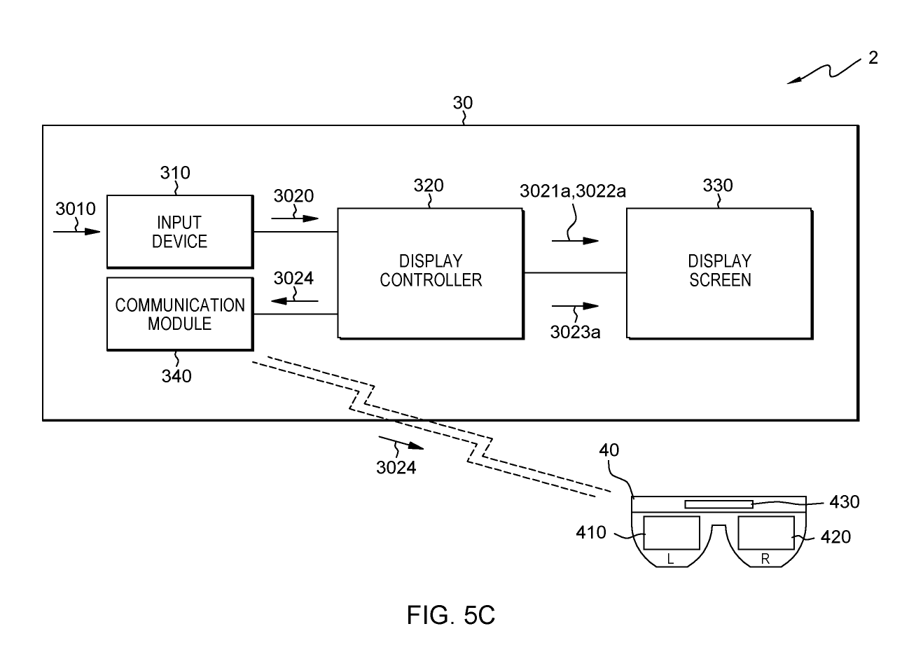

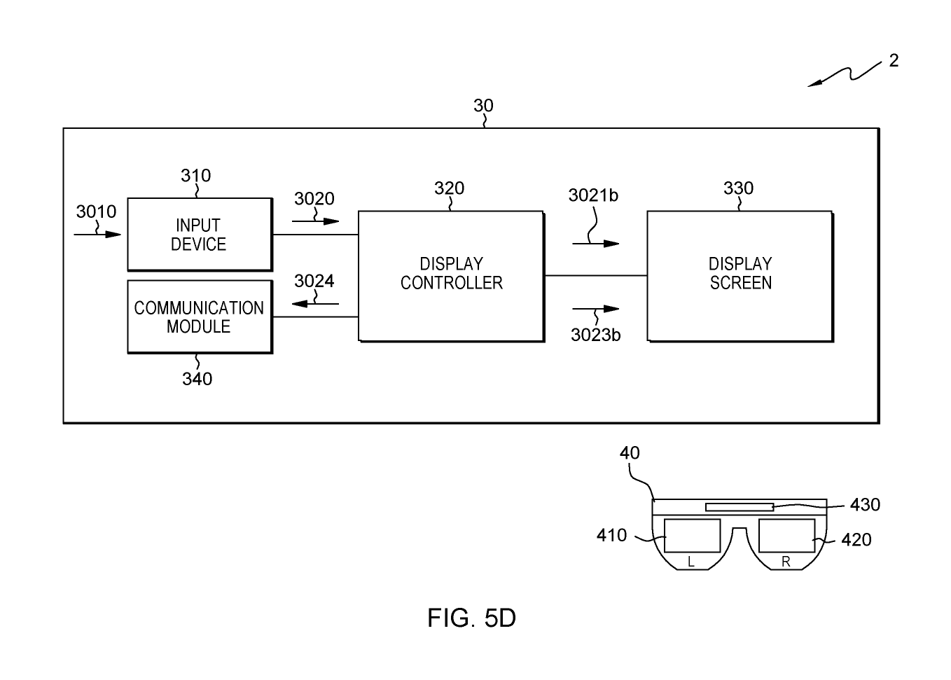

FIG. 5A depicts a block diagram of an example display system 2 in which a display mode is switched between a protection mode and a non-protection mode according to an exemplary embodiment of the present disclosure. FIGS. 5B-5D are example diagrams illustrating how the display system 2 of FIG. 5A operates according to a selected display mode according to an exemplary embodiment of the present disclosure.

In the context of the present disclosure, it is understood that the protection mode is a mode in which a display system is driven to protect an image on a display screen from being seen by unauthorized viewers, as described with reference to FIGS. 1, 2A-2C, 3, 4A, and 4B. On the other hand, it is understood that non-protection mode is a mode in which a display system is driven to display an image on a display screen with no such protection effort. By way of example, when the display system is driven in a two-dimensional (2D) or three-dimensional (3D) display mode, the display system is understood as being driven in the non-protection mode.

Referring to the example depicted in FIG. 5A, the display system 2 may include a display apparatus 30 for displaying an image and a viewing device 40 that helps a viewer see the image. The display apparatus 30 may include an input device 310, a display controller 320, a display screen 330 (e.g., display panel), and a communication module 340.

The input device 310 may receive image data (e.g., RGB) corresponding an image from an external source (e.g., computing system, media player, etc.) locally or remotely connected to the display apparatus 30, and provide the image data 3020 to the display controller 320. The input device 310 may further receive a mode selection input 3010 provided by a viewer or other external source. The display controller 320 may generate one or more image signals with a scan control signal (e.g., a gate driving signal) based on the image data 3020. The display screen 330 may display an image based on the one or more image signals and the scan control signal.

FIG. 5B is an example diagram illustrating that the display system 2 of FIG. 5A operates in a protection mode according to an exemplary embodiment of the present disclosure. Referring to the example depicted in FIG. 5B, when the mode selection input 3010 indicates a protection mode, the display controller 320 may be configured to generate first and second image signals 3021 and 3022 and a scan control signal 3023; the display screen 330 may display a desired image (not shown) based on the first image signal 3021 and an interfering image (not shown) based on the second image signal 3022; and the viewing device 40 may be configured to select (or pass) the desired image 331(FIG. 4A) and block the interfering image 332 (FIG. 4A). The display system 2 described with reference to FIGS. 5A and 5B may have substantially the same configuration and operations as the respective display system 1, 1a, and/or 1b of FIGS. 1, 2A-2C, 3, 4A, and/or 4B when the display system 2 is driven in the protection mode. Thus, duplicate descriptions thereof will be omitted for the sake of simplicity. As was described with reference to FIGS. 1, 3, and 4B, a viewing device control signal 3024 (e.g., the polarization control signal 1024 of FIG. 3 and the shutter glass control signal 1025 of FIG. 4B) may be generated by the display controller 320 and transmitted through the communication module 340 to a communication module 430 of the viewing device 40, as shown in FIG. 5B.

In some embodiments, when the display system 2 is implemented based on a polarization-based protection scheme as was described with reference to FIGS. 2A-2C and 3, left-eye and right-eye lenses 410 and 420 of the viewing device 40 may be configured to have the same or similar polarization direction as a polarization direction of the desired image 331, based on the viewing device control signal 3024.

In some embodiments, when the display system 2 is implemented based on a time division-based protection scheme as described with reference to FIGS. 4A and 4B, the left-eye and right-eye lenses 410 and 420 of the viewing device 40 may be configured to be open and closed in synchronization with the desired image 131 being displayed in the screen 330, based on the viewing device control signal 3024. For example, the left-eye and right-eye lenses 410 and 420 of the viewing device 40 may be configured to be open during the time frames (e.g., T1) where the desired image 131 is displayed and closed during the time frames (e.g., T2) where the interfering image 132 is displayed.

Referring to the example depicted in FIG. 5C, when the mode selection input 3010 indicates a 3D mode, the display controller 320 may be configured to generate a left eye image signal 3021a and a right eye image signal 3022a, and the display screen 330 may display a left eye image (not shown) based on the left eye image signal 3021a and a right eye image (not shown) based on the right eye image signal 3022a. Further, the left-eye lens 410 of the viewing device 40 may be configured to select (or pass) the left eye image and block the right eye image, and the right-eye lens 420 of the viewing device 40 may be configured to select (or pass) the right eye image and block the left eye image, so that, when selected to pass, the left and right images passing through the respective lenses 410 and 420 may be combined to give a perception of 3D depth to a viewer.

Referring to FIG. 5D, when the mode selection input 3010 indicates a 2D mode, the display controller 320 may be configured to generate a 2D image signal 3021b with a scan control signal 3023b, and the display screen 330 may display a 2D image (not shown) based on the 2D image signal 2021b. In this case, the viewing device 40 might not be needed for the viewer to see the 2D image.

Since the configuration and operations to implement the 3D or 2D displays are well known in the art, more detailed description thereof will be omitted for the sake of simplicity.

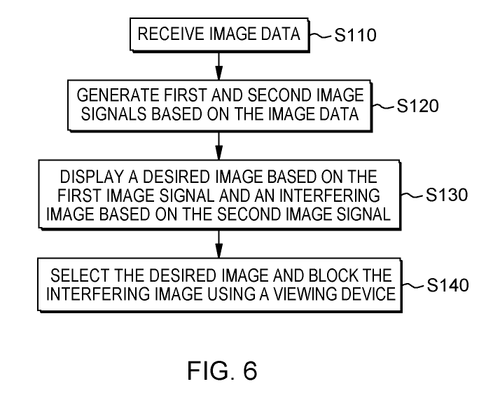

FIG. 6 is a flow chart illustrating a method driving a display system according to an exemplary embodiment of the present disclosure.

Referring to FIG. 6, a method driving a display system according to an exemplary embodiment of the present disclosure may begin with receiving image data (e.g., 1010) by a display controller (e.g., 120) (S110). Next, at step S120, the display controller may generate the first and second image signals (e.g., 1021 and 1022) based on the image data, and a display screen (e.g., 130) may display a desired image (e.g., 131) based on the first image signal and an interfering image (e.g., 132) based on the second image signal (S130). Next, at step S140, a viewing device (e.g., 20) may be controlled to select (or pass) the desired image and block the interfering image.

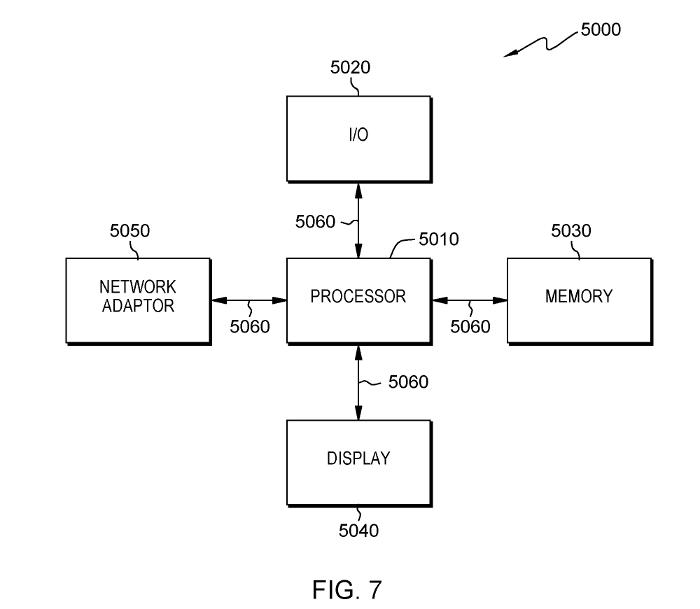

FIG. 7 is a block diagram of a computing system 5000 according to an exemplary embodiment of the present invention.

Referring to FIG. 7, the computing system 5000 may be used as a platform for performing (or controlling) the functions or operations described hereinabove with respect to the systems 1, 1a, 1b, and/or 2 of FIGS. 1, 3, 4B, and 5A, and/or methods of FIG. 6.

In addition, the computing system 5000 may be implemented with an UMPC, a net-book, a PDA, a portable computer (PC), a web tablet, a wireless phone, a mobile phone, a smart phone, an e-book, a PMP, a portable game console, a navigation device, a black box, a digital camera, a DMB player, a digital audio recorder, a digital audio player, a digital picture recorder, a digital picture player, a digital video recorder, a digital video player, or the like.

Referring to FIG. 7, the computing system 5000 may include a processor 5010, I/O devices 5020, a memory system 5030, a display device 5040, and a network adaptor 5050.

The processor 5010 may drive the I/O devices 5020, the memory system 5030, the display device 5040, and the network adaptor 5050 through a bus 5060.

The computing system 5000 may include a program module (not shown) for performing (or controlling) the functions or operations described hereinabove with respect to the systems 1, 1a, 1b, and/or 2 of FIGS. 1, 3, 4B, and 5A, and/or methods of FIG. 6 according to exemplary embodiments. For example, the program module may include routines, programs, objects, components, logic, data structures, or the like, for performing particular tasks or implement particular abstract data types. The processor (e.g., 5010) of the computing system 5000 may execute instructions written in the program module to perform (or control) the functions or operations described hereinabove with respect to the systems 1, 1a, 1b, and/or 2 of FIGS. 1, 3, 4B, and 5A, and/or methods of FIG. 6. The program module may be programmed into the integrated circuits of the processor (e.g., 5010). In an exemplary embodiment, the program module may be stored in the memory system (e.g., 5030) or in a remote computer system storage media.

The computing system 5000 may include a variety of computing system readable media. Such media may be any available media that is accessible by the computer system (e.g., 5000), and it may include both volatile and non-volatile media, removable and non-removable media.

The memory system (e.g., 5030) can include computer system readable media in the form of volatile memory, such as random access memory (RAM) and/or cache memory or others. The computer system (e.g., 5000) may further include other removable/non-removable, volatile/non-volatile computer system storage media.

The computer system (e.g., 5000) can communicate with one or more devices using the network adapter (e.g., 5050). The network adapter may support wired communications based on Internet, LAN, WAN, or the like, or wireless communications based on CDMA, GSM, wideband CDMA, CDMA-2000, TDMA, LTE, wireless LAN, Bluetooth, or the like.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. The embodiment was chosen and described in order to best explain the principles of the present disclosure and the practical application, and to enable others of ordinary skill in the art to understand the present disclosure for various embodiments with various modifications as are suited to the particular use contemplated.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A computer-implemented method for driving a display system, comprising:
receiving one or more image data;
generating a first image signal and a second image signal based on the one or more image data, responsive to receiving an input indicating a screen protection mode,
displaying a first image on a display screen of the display system based on the first image signal;
displaying a second image on the display screen based on the second image signal;
receiving the first and second images displayed on the display screen by a viewing device; and
passing through the first image by the viewing device and blocking the second image by the viewing device, so that a viewer wearing the viewing device indentifies the first image,
wherein left-eye and right-eye lenses of the viewing device are configured to operate in a same manner.

2. The method of claim 1, wherein the first image has a first polarization direction, and the second image has a second polarization direction different from the first polarization direction.

3. The method of claim 2, wherein the left-eye and right-eye lenses have the first polarization direction to pass through the first image with the first polarization direction and block the second image with the second polarization direction.

4. The method of claim 1, wherein the first image is displayed on the display screen during a first time period, and the second image is displayed on the display screen during a second time period exclusive to the first time period.

5. The method of claim 4, wherein the viewing device comprises left-eye and right-eye lenses which are open during the first time period and closed during the second time period.

6. The method of claim 5, wherein the viewing device is driven in synchronization with the display system.

7. The method of claim 1, further comprising:
driving the display screen in a three-dimensional (3D) display mode, responsive to receiving an input indicating a 3D display mode, and
driving the display screen in a two-dimensional (2D) display mode, responsive to receiving an input indicating a 2D display mode.

8. A display system, comprising:
a control device receiving one or more image data and generating a first image signal and a second image signal based on the one or more image data, responsive to receiving an input indicating a screen protection mode;
a display screen displaying a first image based on the first image signal and a second image based on the second image signal; and
a viewing device passing through the first image and blocking the second image, so that a viewer wearing the viewing device indentifies the first image,
wherein left-eye and right-eye lenses of the viewing device are configured to operate in a same manner.

9. The system of claim 8, wherein the first image has a first polarization direction, and the second image has a second polarization direction different from the first polarization direction.

10. The system of claim 9, wherein the left-eye and right-eye lenses have the first polarization direction to pass through the first image with the first polarization direction and block the second image with the second polarization direction.

11. The system of claim 8, wherein the first image is displayed on the display screen during a first time period, and the second image is displayed on the display screen during a second time period exclusive to the first time period.

12. The system of claim 11, wherein the viewing device comprises left-eye and right-eye lenses which are open during the first time period and closed during the second time period.

13. The system of claim 8, further comprising:
a first communication module generating and transmitting a control signal to a second communication module of the viewing device.

14. The system of claim 13, wherein the viewing device is driven in synchronization with the display system using the control signal.

15. A computer program product comprising a computer-readable storage medium having computer readable program instructions embodied therewith, the computer readable program instructions executable by at least one processor to cause a computer to perform a computer-implemented method for driving a display system, wherein the method comprises:
receiving one or more image data;
generating a first image signal and a second image signal based on the one or more image data, responsive to receiving an input indicating a screen protection mode,
displaying a first image on a display screen of the display system based on the first image signal;
displaying a second image on the display screen based on the second image signal; and
passing through the first image displayed on the display screen by a viewing device and blocking the second image displayed on the display screen by the viewing device, so that a viewer wearing the viewing device indentifies the first image,
wherein left-eye and right-eye lenses of the viewing device are configured to operate in a same manner.

16. The computer program product of claim 15, wherein the first image has a first polarization direction, and the second image has a second polarization direction different from the first polarization direction

17. The computer program product of claim 16, wherein the left-eye and right-eye lenses have the first polarization direction to select the first image with the first polarization direction and block the second image with the second polarization direction.

18. The computer program product of claim 15, wherein the first image is displayed on the display screen during a first time period, and the second image is displayed on the display screen during a second time period exclusive to the first time period.

19. The computer program product of claim 18, wherein the viewing device comprises left-eye and right-eye lenses which are open during the first time period and closed during the second time period.

20. The computer program product of claim 19, wherein the viewing device is driven in synchronization with the display system.
